(19) United States
(12) Patent Application Publication
(10) Pub. No.: US 2011/0008556 A1
(43) Pub. Date: Jan. 13, 2011

(54) METHOD FOR MAKING A HOUSING HAVING A METALLIC APPEARANCE AND A HOUSING MADE BY THE METHOD

(75) Inventors: Zheng SHI, Shenzhen City (CN); Dian-Hong YE, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/575,885

(22) Filed: Oct. 8, 2009

(30) Foreign Application Priority Data
Jul. 8, 2009 (CN) 200910304135.6

(51) Int. Cl. B44C 1/00; B32B 37/00; B32B 7/12

(52) U.S. Cl. 428/35.9; 156/256; 428/35.7; 428/36.1

(57) ABSTRACT

A method for making a housing having a metallic appearance, comprising the steps of: providing a plastic substrate; providing a decorative film, the decorative film having an outer surface and an inner surface; forming a nonconductive plated coating on the outer surface, the nonconductive plated coating having a metallic appearance; processing the decorative film to achieve a predetermined shape, the predetermined shape matching with the plastic substrate; processing the decorative film by trimming the excess portions of the decorative film beyond the predetermined shape; forming an adhesive layer on the inner surface of the decorative film or on the plastic substrate surface; bonding the decorative film to the plastic substrate. A housing for electronic devices is also described.

### BACKGROUND

1. Technical Field

The present disclosure generally relates to housings of electronic devices with a metallic appearance and methods for making the same.

2. Description of Related Art

Plastic housings for electronic devices having a metallic appearance are attractive. In order to acquire a metallic appearance and not tamper with the radio frequency (RF), plastic housings are typically plated a nonconductive metallic coating by a nonconductive vacuum metallization (NCVM). However, the preformed plastic housings usually have some slight defects, e.g. stains on surfaces. Further, these slight defects may result in serious damage to the metallic appearance of the metallic coating during the process of NCVM.

In-Mold Labeling (IML) is another method for producing such decorative plastic housings. A preformed plastic film with a decorative layer of metallic ink can be in-mold labeled with a plastic substrate within a mold. However, the metallic ink usually cannot present a real, glossy metallic appearance.

Therefore, there is room for improvement within the art.

### BRIEF DESCRIPTION OF THE DRAWINGS

Many aspects of the method for making housing with a metallic appearance and housing made by the same can be better understood with reference to the following drawings. The components in the drawing are not necessarily to scale, the emphasis instead being placed upon clearly illustrating the principles of the present method and housing made by the same.

FIG. 1 is a block diagram of an exemplary process for making the housing.

FIG. 2 is a cross-section view of an exemplary embodiment of the present housing.

### DETAILED DESCRIPTION OF THE EXEMPLARY EMBODIMENT

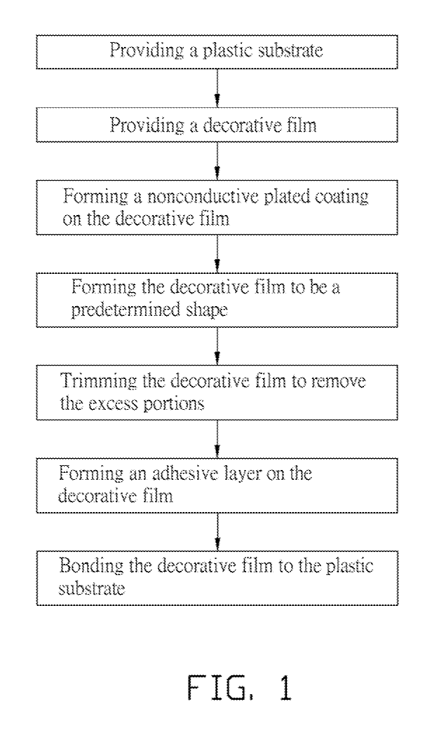

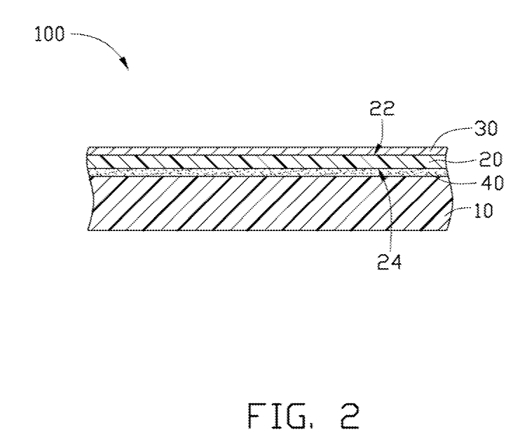

FIG. 1 shows an exemplary method for making the housing 100 (shown in FIG. 2), which includes at least the following steps.

A plastic substrate 10 is provided. The plastic substrate 10 can be molded from a plastic material.

A decorative film 20 is provided. The decorative film 20 may be made of plastic, e.g., polymethyl methacrylate (PMMA), polyvinyl chloride (PVC), or polycarbonate (PC). Alternatively, the decorative film 20 may be leather or fabric. The decorative film 20 has an outer surface 22 and an inner surface 24.

A nonconductive plated coating 30 is formed on the outer surface 22 of the decorative film 20, for example by implementing a vacuum evaporating method or a vacuum sputtering method. The nonconductive plated coating 30 has a metallic appearance. The nonconductive plated coating 30 can be made of one or more materials selected from a group consisting of indium, aluminum, titanium, tin, chromium, aurum, vanadium, stainless steel and indium-tin alloy.

The decorative film 20 with the nonconductive plated coating 30 is processed to achieve a predetermined shape for example by a vacuum forming or a pressure forming Accordingly, the decorative film 20 has a three-dimensional shape for matching the shape of the plastic substrate 10.

The decorative film 20 having the predetermined shape is processed by trimming the excess portions of the decorative film 20 beyond the predetermined shape using a laser cutting or a machining cutting.

An adhesive layer 40 is formed (e.g., sprayed or printed) on the inner surface 24 of the decorative film 20. Alternatively, the adhesive layer 40 can be formed on the surface of the plastic substrate 10.

The decorative film 20 is bonded to the surface of the plastic substrate 10 by the adhesive layer 40.

It should be understood, a pressing force may be further applied to the plastic substrate 10 against the decorative film 20 to strengthen the bonding of decorative film 20 and the plastic substrate 10 after the bonding step.

FIG. 1 shows a housing 100 made by the method as described above. The housing 100 includes the plastic substrate 10, the decorative film 20, the nonconductive plated coating 30, and the adhesive layer 40. The nonconductive plated coating 30 is formed on the outer surface 22. The adhesive layer 40 is formed on the inner surface 24. The decorative film 20 is bonded with the plastic substrate 10 by the adhesive layer 40. The nonconductive plated coating 30 has a metallic appearance.

The housing 100 made by the present method having the nonconductive plated coating 30 has a high glossy, metallic appearance. The nonconductive plated coating 30, being formed on the decorative film 20 but not directly formed on the plastic substrate 10, may insure a good metallic appearance with no defect. Moreover, it is low coast by using an adhesive to bond the decorative film 20 and the plastic substrate 10.

It should be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for making a housing having a metallic appearance, comprising the steps of:
providing a plastic substrate;
providing a decorative film, the decorative film having an outer surface and an inner surface;
forming a nonconductive plated coating on the outer surface, the nonconductive plated coating having a metallic appearance;
processing the decorative film with the nonconductive plated coating to achieve a predetermined shape, the predetermined shape matching the shape of the plastic substrate;
processing the decorative film by trimming the excess portions of the decorative film beyond the predetermined shape;
forming an adhesive layer on the inner surface of the decorative film or on the plastic substrate surface;
bonding the decorative film to the plastic substrate.

2. The method for a making housing having a metallic appearance as claimed in claim 1, wherein the plastic substrate is molded from a plastic material.

3. The method for making a housing having a metallic appearance as claimed in claim 1, wherein the decorative film is made of plastic.

4. The method for making a housing having a metallic appearance as claimed in claim 1, wherein the decorative film is leather or fabric.

5. The method for making a housing having a metallic appearance as claimed in claim 1, wherein the nonconductive plated coating is formed by a vacuum evaporating method or a vacuum sputtering method.

6. The method for a making housing having a metallic appearance as claimed in claim 1, wherein the nonconductive plated coating is made of one or more materials selected from a group consisting of indium, aluminum, titanium, tin, chromium, aurum, vanadium, stainless steel and indium-tin alloy.

7. The method for making a housing having a metallic appearance as claimed in claim 1, wherein the predetermined shape of the decorative film is formed by vacuum forming or by pressure forming.

8. The method for making a housing having a metallic appearance as claimed in claim 1, wherein the method further comprises applying a pressing force to the plastic substrate against the decorative film after the bonding step.

9. A housing, comprising:
a plastic substrate;
a decorative film, the decorative film having an outer surface and an inner surface;
a nonconductive plated coating formed on the outer surface of the decorative film, the nonconductive plated coating having a metallic appearance; and
an adhesive layer bonding the inner surface of the decorative film with the plastic substrate.

10. The housing as claimed in claim 9, wherein the plastic substrate is molded from a plastic material.

11. The housing as claimed in claim 9, wherein the decorative film made of a material selected from plastic, leather, and fabric.

12. The housing as claimed in claim 9, wherein the nonconductive plated coating is made of one or more materials selected from a group consisting of indium, aluminum, titanium, tin, chromium, aurum, vanadium, stainless steel and indium-tin alloy.
